(19) United States
(12) Patent Application Publication
(10) Pub. No.: US 2017/0032414 A1
(43) Pub. Date: Feb. 2, 2017

(54) CONTROLLING OF ONLINE AD SERVING CAMPAIGNS

(71) Applicant: Linkedin Corporation, Mountain View, CA (US)

(72) Inventors: Venkata S.J.R. Bhamidipati, Fremont, CA (US); Linda Leung, Mountain View, CA (US); Dakan Wang, Mountain View, CA (US); Dominic Law, Sunnyvale, CA (US)

(21) Appl. No.: 14/813,831

(22) Filed: Jul. 30, 2015

(51) Int. Cl. G06Q 30/02; G06Q 50/00

(52) U.S. Cl. CPC G06Q 30/0249; G06Q 30/0273; G06Q 50/01

(57) ABSTRACT

A machine may be configured to control online ad serving based on a period budget. For example, the machine accesses event data pertaining to an event of online ad consumption of an online ad included in a campaign. The campaign is one of one or more campaigns associated with an account. The machine identifies, based on the event data, an account identifier associated with the online ad. The machine accesses a remaining period budget value associated with the account identifier. The remaining period budget value represents a budget amount remaining to be spent, during a period of time, on one or more online ads that are associated with the one or more campaigns. The machine determines that the remaining period budget value exceeds an event cost value associated with the event. The machine adjusts the remaining period budget value based on the event cost value.

### TECHNICAL FIELD

The present application relates generally to the processing of data, and, in various example embodiments, to systems, methods, and computer program products for controlling of online ad serving campaigns.

### BACKGROUND

Online advertising debuted as a new advertising medium in the mid-1990s to allow advertisers to promote their products and services on the Internet. Publishers (e.g., website owners) ran online ads on their web sites for the advertisers. The earliest ad serving software utilized by the publishers allowed the display of banner ads in the browsers of the users visiting the publishers' websites. In time, other types of online advertising have appeared, such as sponsored ads, affiliate ads, pay-per-click ads, etc.

As online advertising became more prevalent, certain methods for selling online advertising became more common. The Cost Per Thousand (also “CPM”) model was one of the earliest forms of selling online advertising and was based on an agreed rate for every one thousand impressions served. The Cost Per Click (also “CPC) model was often used and allowed publishers to charge advertisers a higher rate when users clicked on ads.

In addition to selling ad spots on their websites, the publishers are responsible to some degree for managing the advertising on their web sites. Generally, the publisher ensures that the online advertising campaign is set up properly and is receiving the online traffic promised to the advertiser. An online advertising campaign (also “advertising campaign,” “ad campaign,” or “campaign”) may specify one or more types of advertising products (also “ad products”) to be delivered during a campaign delivery period and a collection of common settings that a creative or a group of creatives associated with an ad product should abide by. A creative is a form of advertising material, such as a banner, Hyper Text Markup Language (HTML) form, Flash file, etc. Common creative types include Graphics Interchange Format (GIF), Joint Photographic Experts Group (JPEG), Java, HTML, Flash, or streaming audio/video.

Generally, the publisher also provides reports regarding the advertising campaign to the advertiser. These reports may include campaign performance reports and billing reports. At the most basic level, billing reports provide an accounting of delivered ads (e.g., within certain campaigns) and costs associated with the delivered ads or campaigns, billable to the advertiser.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a control system, according to some example embodiments;

FIG. 3 is a flowchart illustrating a method for controlling of online ad serving based on a period budget, according to some example embodiments;

FIG. 4 is a flowchart illustrating a method for controlling of online ad serving based on a period budget, and representing additional steps of the method illustrated in FIG. 3, according to some example embodiments;

FIG. 5 is a flowchart illustrating a method for controlling of online ad serving based on a period budget, and representing additional steps of the method illustrated in FIG. 3, according to some example embodiments;

FIG. 6 is a flowchart illustrating a method for controlling of online ad serving based on a period budget, and representing additional steps of the method illustrated in FIG. 3, according to some example embodiments;

FIG. 7 is a flowchart illustrating a method for controlling of online ad serving based on a period budget, and representing additional steps of the method illustrated in FIG. 3, according to some example embodiments;

FIG. 8 is a flowchart illustrating a method for controlling of online ad serving based on a period budget, and representing step 306 of FIG. 3 in more detail, and additional steps of the method illustrated in FIG. 3, according to some example embodiments; and

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems for controlling of online ad serving based on a period budget are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In some example embodiments, a social networking service, such as LinkedIn®, is a publisher of online advertising that publishes (e.g., displays, presents, serves, or shows) online ads on behalf of one or more advertisers. Advertisers may come to the publisher to reach members of the social networking service and build long-term relationships with them through online advertising campaigns. The members of the social networking service may be a unique audience, and the social networking service may have a unique context that is very hard to find at scale anywhere else.

In some instances, the publisher utilizes an advertising auction to identify, from among the online ads of a number of advertisers, an online ad (also an “ad”) to be shown to a particular target audience. For example, when a page that can display an online ad loads on a web page of the publisher or a member scrolls through the member's web feed (e.g., a data format used for providing members with frequently updated content) provided by the publisher, the publisher periodically generates an online ad (e.g., a Sponsored Update, InMail, etc.). When there is an opportunity for an online ad to be shown, the publisher runs an auction to determine which online ad to show. For any given auction, there can be many bids from competing advertisers looking to reach the member.

An advertiser may choose to pay when the ad is shown (based on the CPM model) or when people click on the ad (based on the CPC model). The CPM model is often preferred when the advertiser wants to ensure that the ad is shown to as many people in a target audience as possible. The CPC model may be preferred for performance advertising, when the advertiser wants the publisher to show the ad to a target audience whose members are most likely to click on the content of the ad. Under the CPC model, the advertiser pays when someone in a particular target audience clicks on the content, company name, or company logo as presented in or with the ad.

In some example embodiments, the auction utilized by the publisher is a second price auction. Generally, in a second price auction, the advertiser is charged just enough to beat the second highest bidder. For example, the winning advertiser has a bid of $5.00 cost per click, but the next highest bid is only $3.00. That means the winning advertiser only pays $3.01. This second price method lets each advertiser bid the absolute maximum they are willing to pay, but they are only charged just enough to win the auction.

Traditionally, in addition to identifying auction winning ads and serving the ads to the target audience, the publisher tracks the online ad consumption events pertaining to interactions by users with the online ads (e.g., impressions, clicks, conversions, etc.). The publisher may also generate reports that indicate the costs associated with the online ad consumption events (also “ad consumption events,” “consumption events,” or “events”).

In some example embodiments, an advertiser, in order to win an online advertising auction, chooses to make a high bid for one or more online ads. The advertiser may also wish to control the amount spent for the one or more online ads based on a variety of factors. A control system is designed to control the amount spent by an advertiser on online ads at a number of levels, such as at a time-based level (e.g., “the period budget for January is $1,000.00” or “the daily budget is $50.00”), an account level (e.g., “the total budget that Company ABC would like to spend on all its online advertising with the publisher is $5,000.00”), an item line or a goal level (e.g., “Company ABC would like to spend $1,000.00 to gain 1,000 followers”), a campaign-group level (e.g., “Company ABC would like to spend $10,000.00 on Campaign 1 and Campaign 2 advertising New Product”), a campaign level (e.g., “Company ABC would like to spend $500.00 on Campaign 5”), etc. Further, additional levels of budget control may seamlessly be added to the control system.

In some instances, an ad delivery system over-delivers online ads above a particular budget set by the advertiser. For example, a remaining budget value associated with a particular ad should be updated (e.g., decreased) based on the costs of the ad consumption events associated with the particular ad. Due to a system failure, the remaining budget value is not being updated and represents an erroneous amount. Based on the erroneous value of the remaining budget, the publisher continues to serve the particular ad. This leads to the over-delivery of the particular ad above the budget value set by the advertiser associated with the particular ad. The various levels of budget control of the ad spending may contribute to a reduction in the over-delivery of online ads.

The control system may facilitate the control of online ad serving during a particular period of time based on a period budget value associated with the particular period of time. As a result, the control system also facilitates the control of the amount spent, by an advertiser, on online advertising during the particular period of time based on the period budget value associated with the particular period of time. An advertiser may specify a maximum period budget value to be spent during a particular period of time. The control system may manage a number of campaigns associated with the advertiser, and limit the ad spending on the campaigns based on the maximum period budget value specified by the advertiser.

For example, an advertiser makes a bid of $100.00 for a first online advertising product associated with a first campaign to be provided to users by the publisher on behalf of the advertiser during a period of time (e.g., a particular week). The advertiser also makes a bid of $200.00 for a second advertising product associated with a second campaign to be provided to users by the publisher on behalf of the advertiser during the period of time. Further, the advertiser sets a daily budget value of $50.00 that corresponds to a maximum amount to be spent on the two campaigns during any particular day of the period of time. In some instances, the advertiser is associated with an account that includes the first and second campaigns. The first and second campaigns include online ads to be presented on behalf of the advertiser. The bids and the budget values set by the advertiser may be associated with an account identifier that corresponds to the account. The control system may generate a remaining period budget value (e.g., a remaining daily budget value) for tracking the remaining amount that may be spent during a particular period of time.

In the example above, before a first event of consumption of an online ad associated with one of the two campaigns is registered, the control system sets the remaining daily budget value to correspond to the daily budget value of $50.00. The control system may receive event data (e.g., event notifications) pertaining to online ad consumption events associated with the two campaigns, and may adjust the remaining period budget value based on the event cost values of the events. As new events are registered (e.g., by an event tracking system), the remaining period budget value is decreased based on the event cost values associated with the respective events. At some point, the control system determines that the remaining period budget value is exceeded by the event cost value of a recent event. The control system causes the two campaigns to stop (e.g., de-activate) based on the determination that the remaining period budget value is exceeded by the event cost value of the recent event. In some example embodiments, when the remaining period budget value is exceeded, the control system marks the two campaigns as paused (e.g., in a record of a database). Later, during the remainder of the particular period of time (e.g., the particular day), an ad serving system of the publisher does not select ads from the paused campaigns to present to users. When the particular period ends, the control system marks the two campaigns as active (e.g., in the record of the database). Upon the two campaigns being activated, the ad serving system may again select ads from the two campaigns to be shown to users.

In some example embodiments, the control system detects the beginning of a further period of time, accesses (e.g., identifies) a further period budget value associated with the further period of time, and causes the re-activation of the two campaigns associated with the advertiser (e.g., with an account identifier that identifies an account corresponding to the advertiser).

The control system may support various budget values for a variety of periods of time, such as hourly, daily, weekly, monthly, yearly, lifetime, etc., or any suitable combination thereof. The control system also supports various budget values for customized periods of time, such as certain hours (e.g., morning hours, evening hours, etc.), certain days (e.g., Monday through Friday, Saturday and Sunday, etc.), certain seasonal times (e.g., holidays, etc.), or any suitable combination thereof.

For example, a campaign that is to last two weeks is associated with a campaign budget value of $500.00. A first period budget value of $100.00 is specified for a first period of time from 10:00 a. m. to 11:00 a. m., Monday through Friday. A second period budget value of $50.00 is specified for a second period of time from 4:00 p. m. to 5:00 p. m., Monday through Friday. For the rest of the time during the two weeks of the campaign, no other period spending cap is specified. The control system adjusts the remaining first period budget value and the remaining second period budget value based on the events cost values of the events of consumptions of the ads included in the campaign, that are registered between 10:00 a. m. and 11:00 a. m., Monday through Friday, and 4:00 p. m. to 5:00 p. m., Monday through Friday, respectively. On Tuesday of the first week of the campaign, the control system determines that, at 10:30 a. m., the remaining first period budget value was exceeded (based on a comparison between the remaining first period budget value and the event cost value of a recent event). The control system causes the deactivation of the campaign for the remainder of the first period of time, the “10:00 a.m. to 11:00 a. m.” period of time (e.g., between 10:30 a. m. and 11:00 a. m.). At the expiration of the first period of time, the control system causes the re-activation of the campaign. Between 11:00 a. m. and 4:00 p. m., the campaign runs without a period budget cap. At 4:00 p. m. (e.g., the beginning of the second period of time, the “4:00 p. m. to 5:00 p. m.” period of time), the control system accesses the remaining second budget value associated with the second period of time and adjusts the remaining second budget value based on one or more incoming events registered during the second period of time. After each incoming event, the control system verifies whether the event cost value of the event exceeds the remaining second budget value. If the control system determines that the remaining second budget value is exceeded during the second period of time, the control system deactivates the campaign for the remainder of the second period of time. At the expiration of the second period of time, the control system re-activates the campaign, and the campaign runs without a period budget cap until Wednesday, 10:00 a.m., when the first period budget cap associated with the first period, “10:00 a.m. to 11:00 a. m.,” again goes into effect.

In some example embodiments, the control system accesses event data pertaining to an event of online ad consumption of an online ad included in a campaign. The campaign is one of one or more campaigns associated with an account. The control system identifies, based on the event data, an account identifier associated with the online ad. The control system also accesses a remaining period budget value associated with the account identifier. The remaining period budget value represents a budget amount remaining to be spent, during a period of time, on one or more online ads including the online ad that are associated with the one or more campaigns. The control system determines that the remaining period budget value exceeds an event cost value associated with the event. The control system adjusts the remaining period budget value based on the event cost value.

In certain example embodiment, the event is a first event, and the event cost value is a first event cost value. The control system determines that a second event cost value associated with a second event of online ad consumption exceeds the remaining period budget value. Then, the control system causes a deactivation of the one or more campaigns that are associated with the account for a remainder of the period of time based on the determining that the second event cost value exceeds the remaining period budget value.

In various example embodiments, the period of time is a first period of time, and the remaining period budget value is a first remaining period budget value associated with the first period of time. The control system determines a beginning of a second period of time that is subsequent to the first period of time. The control system also accesses a second remaining period budget value associated with the second period of time. Then, the control system causes a re-activation of the one or more campaigns that are associated with the account based on the determining of the beginning of the second period of time and the identifying of the second remaining period budget value associated with the second period of time.

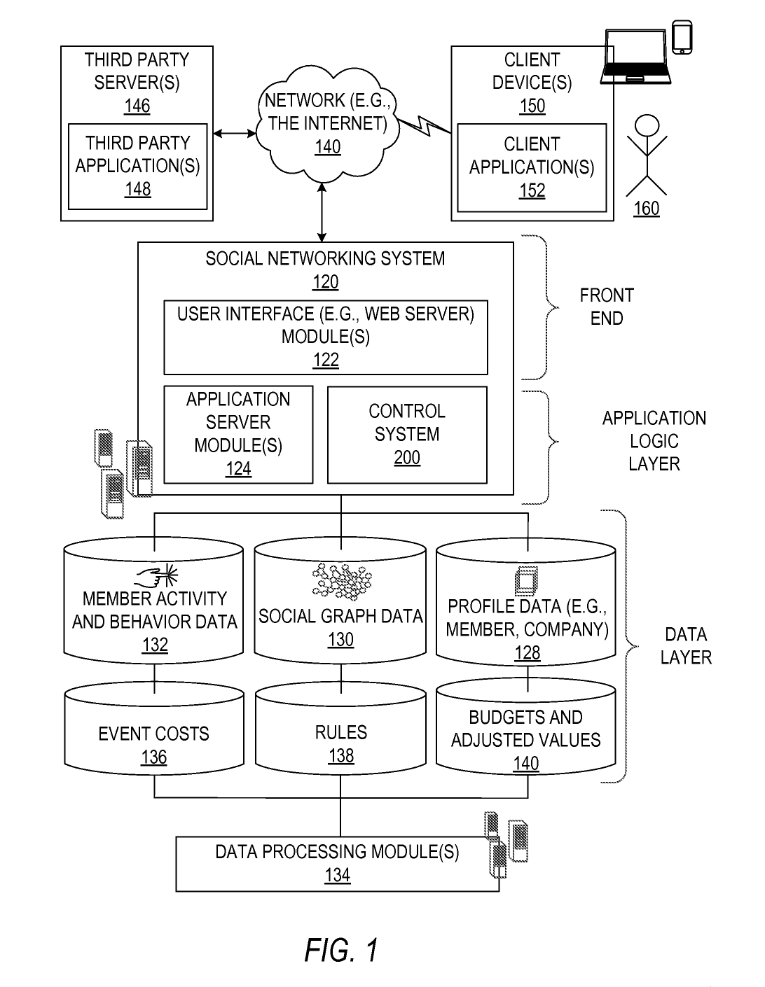

An example method and system for controlling of online ad serving based on a period budget may be implemented in the context of the client-server system illustrated in FIG. 1. As illustrated in FIG. 1, the control system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the control system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, event costs, rules, budget values, or adjusted values, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

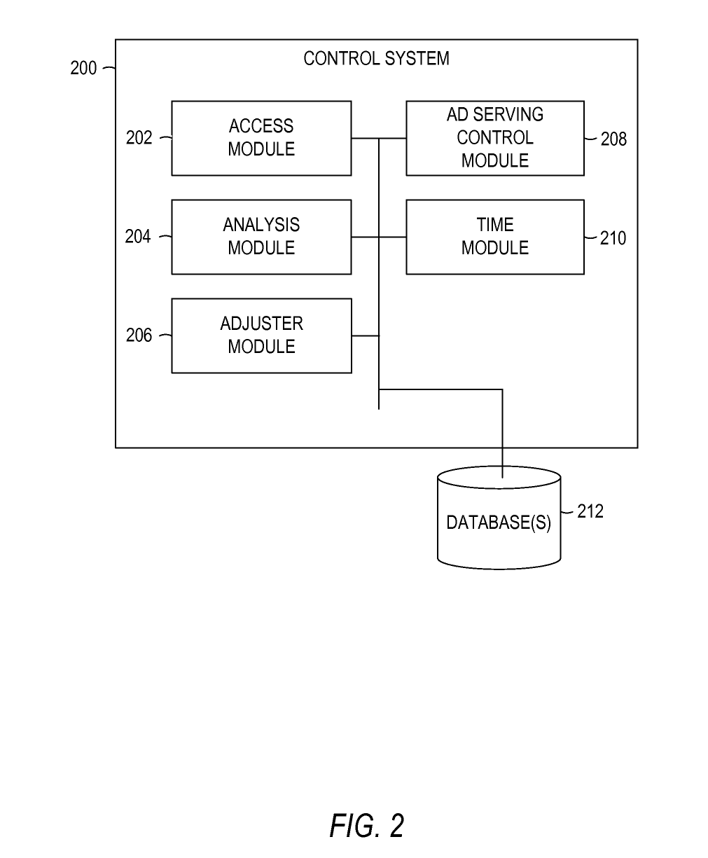

FIG. 2 is a block diagram illustrating components of the control system 200, according to some example embodiments. As shown in FIG. 2, the control system 200 includes an access module 202, an analysis module 204, an adjuster module 206, an ad serving control module 208, and a time module 210, all configured to communicate with each other (e.g., via a bus, shared memory, or a switch).

According to some example embodiments, the access module 202 accesses (e.g., receives or obtains) event data pertaining to an event of online ad consumption of an online ad included in a campaign. The online ad may be displayed by the social networking system 120 on behalf of an advertiser (e.g., an organization, a company, etc.). The advertiser is associated with an account identifier that may be stored in database 128. When the online ad is consumed in an event (e.g., an impression of the online ad is generated), the event data describing the event includes the account identifier to indicate an association of the online ad and the account identifier.

The campaign is one of one or more online ad campaigns associated with the account identifier. The account identifier represents an account that corresponds to the advertiser. The account identifier may be included in the event data pertaining to the event. The access module 202 also identifies, based on the accessed event data, an account identifier associated with the online ad.

The access module 202 also accesses a remaining period budget value associated with the account identifier. The remaining period budget value may be accessed in a database (e.g., the budgets and adjusted values database 140). The remaining period budget value represents a budget amount remaining to be spent, during a period of time, on one or more online ads including the online ad that are associated with the one or more campaigns.

The access module 202 may also access an event cost value associated with the event. In some example embodiments, the event cost value is included in the event data, and may be accessed in the event data. In certain example embodiments, the event cost value access is stored in a database (e.g., event costs database 136), and may be accessed in the database.

The analysis module 204 determines, based on the event cost value and the remaining period budget value, that the remaining period budget value exceeds the event cost value associated with the event. The determining that the remaining period budget value exceeds the event cost value associated with the event may be based on a comparison of the remaining period budget value and the event cost value associated with the event.

The adjuster module 206 adjusts the remaining period budget value based on the event cost value. The adjusting of the remaining period budget value based on the event cost value may include subtracting the event cost value from the remaining period budget value. The resulting difference is an updated (or adjusted) remaining period budget value, and is used to determine whether there is remaining budget for a further event of consumption of the online ad.

In some example embodiments, the event is a first event, and the event cost value is a first event cost value. Upon computing the updated remaining period budget value based on the first event, the updated remaining period budget value is assigned to the remaining period budget value. Then, when a further (e.g., a second) event is registered, the access module 202 accesses the remaining period budget value (that has been updated based on the first event) and an event cost value associated with the second event. The analysis module 204 determines that the remaining period budget value exceeds the second event cost value associated with the second event. The adjuster module 206 adjusts the remaining period budget value based on the second event cost value (e.g., by subtracting the second event cost value from the remaining period budget value).

In certain example embodiments, the adjuster module 206 adjusts, based on the event cost value, a remaining campaign budget value associated with the campaign that includes the online ad. In certain example embodiments, the adjuster module 206 adjusts, based on the event cost value, a remaining account budget value associated with the account that is associated with the campaign that includes the online ad.

In some example embodiments, the event is a first event, and the event cost value is a first event cost value. The analysis module 204 determines that a second event cost value associated with a second event of online ad consumption exceeds the remaining period budget value.

The ad serving control module 208 causes a deactivation of the one or more campaigns that are associated with the account for a remainder of the period of time based on the determining that the second event cost value exceeds the remaining period budget value. In some example embodiments, the causing of the deactivation of the one or more campaigns includes marking (e.g., identifying, tagging, etc.) the one or more campaigns as “paused” for the remainder of the period of time in one or more records of a database. The adjuster module 206 may also adjust the remaining period budget value based on the determination that the second event cost value associated with a second event of online ad consumption exceeds the remaining period budget value. For example, the adjusting of the remaining period budget value based on the determination that the second event cost value exceeds the remaining period budget value includes assigning a zero to the remaining period budget value.

The time module 210 may determine the beginning and expiration of a period of time. In certain example embodiments, the analysis module 204 determines that the one or more campaigns are deactivated for a remainder of the period of time. The time module 210 determines that the period of time has expired. The ad serving control module 208 causes a re-activation of the one or more campaigns based on the determining that the one or more campaigns are deactivated for the remainder of the period of time and the determining that the period of time has expired.

In certain example embodiments, the event is a first event, the event cost value is a first event cost value, the period of time is a first period of time, and the remaining period budget value is a first remaining period budget value associated with the first period of time. The time module 210 identifies an expiration of the first period of time. The access module 202 identifies (e.g., accesses) a second remaining period budget value associated with a second period of time that is subsequent to (e.g., follows after, immediately follows, etc.) the first period of time. The analysis module 204 determines that a second event cost value associated with a second event registered during the second period of time exceeds the second remaining period budget value. The ad serving control module 208 causes a deactivation of the one or more campaigns for a remainder of the second period of time based on the determining that the second event cost value associated with the second event registered during the second period exceeds the second remaining period budget value. In various example embodiments, the time module 210 determines that the second period of time has expired. The ad serving control module 208 causes a re-activation of the one or more campaigns based on the determining that the second period of time has expired.

In various example embodiments, the period of time is a first period of time included in a second period of time. The remaining period budget value is a first remaining period budget value. The second period of time is associated with a second remaining period budget value associated with the account identifier. In some instances, the second remaining period budget value is further associated with a campaign group of the one or more campaigns. In certain instances, the second remaining period budget value is further associated with a line item in a contract between the advertiser associated with the account and the publisher of online ads included in the one or more campaigns. The access module 202 accesses the second remaining period budget value. The analysis module 204 determines that the second remaining period budget value exceeds the event cost value associated with the event. The adjuster module 206 adjusts the second remaining period budget value based on the event cost value.

In some example embodiments, the account identifier is associated with one or more periods of time including the period of time. The account identifier is also associated with one or more remaining period budget values including the remaining period budget value. The one or more remaining period budget values correspond to the one or more periods of time. The time module 210 identifies a present time. The time module 210 also identifies, based on the account identifier, the one or more periods of time associated with the account identifier. The analysis module 204 determines that the present time is included in the period of time. The accessing of the remaining period budget value includes selecting, from the one or more remaining period budget values, the remaining period budget value that corresponds to the period of time including the present time.

To perform one or more of its functionalities, the control system 200 may communicate with one or more other systems. An integration system may integrate the control system 200 with one or more email server(s), web server(s), one or more databases, or other servers, systems, or repositories. A performance system may determine the performance of one or more modules of the control system 200.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 212 (e.g., database 128, 130, 132, 136, 138, or 140).

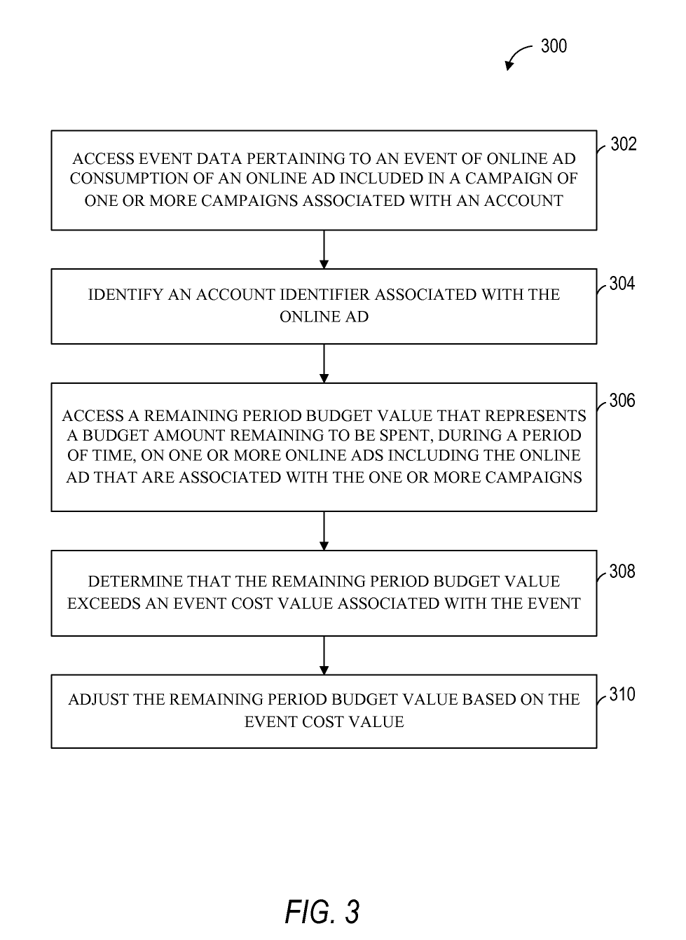

FIGS. 3-8 are flowcharts illustrating a method for controlling of online ad serving based on a period budget, according to some example embodiments. Operations in the method 300 illustrated in FIG. 3 may be performed using modules described above with respect to FIG. 2. As shown in FIG. 3, method 300 may include one or more of method operations 302, 304, 306, 308, and 310, according to some example embodiments.

At method operation 302, the access module 202 accesses event data pertaining to an event of online ad consumption of an online ad included in a campaign. The campaign is one of one or more campaigns associated with an account. The event data may be generated by a server (e.g., an ad server or an event tracking server) as a result of serving the online ad (e.g., sending an email message) or of registering the occurrence of the event of consumption of the online ad (e.g., registering a click-through event).

At method operation 304, the access module 202 identifies, based on the event data, an account identifier associated with the online ad.

At method operation 306, the access module 202 accesses a remaining period budget value associated with the account identifier. The remaining period budget value represents a budget amount remaining to be spent, during a period of time, on one or more online ads including the online ad that are associated with the one or more campaigns.

At method operation 308, the analysis module 204 determines that the remaining period budget value exceeds an event cost value associated with the event. The determination that the remaining period budget value exceeds an event cost value associated with the event may be based on a comparison of the remaining period budget value and the event cost value.

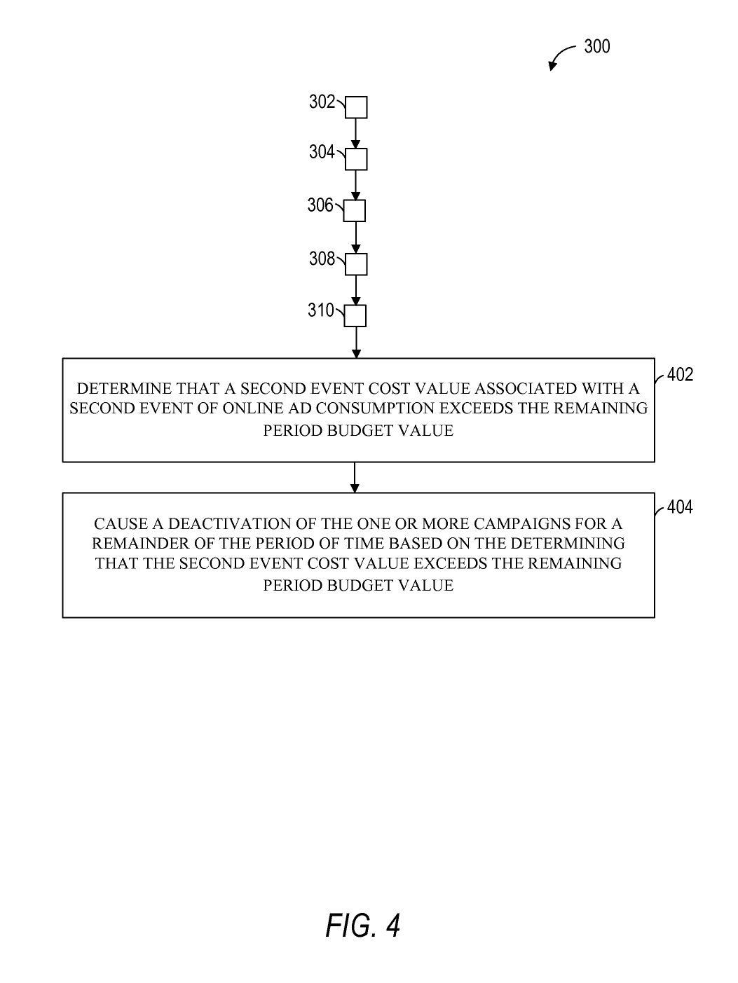

At method operation 310, the adjuster module 206 adjusts the remaining period budget value based on the event cost value. The adjusting of the remaining period budget value may include subtracting the event cost value from the remaining period budget value, and assigning the difference to the remaining period budget value. Further details with respect to the method operations of the method 300 are described below with respect to FIGS. 4-8.

As shown in FIG. 4, the method 300 may include one or more of operations 402 and 404, according to some example embodiments. Method operation 402 may be performed after method operation 310, in which the adjuster module 206 adjusts the remaining period budget value based on the event cost value.

In some example embodiments, the event is a first event, and the event cost value is a first event cost value. At method operation 402, the analysis module 204 determines that a second event cost value associated with a second event of online ad consumption exceeds the remaining period budget value.

Method operation 404 may be performed after method operation 402. At method operation 404, the ad serving control module 208 causes a deactivation of the one or more campaigns that are associated with the account for a remainder of the period of time based on the determining that the second event cost value exceeds the remaining period budget value.

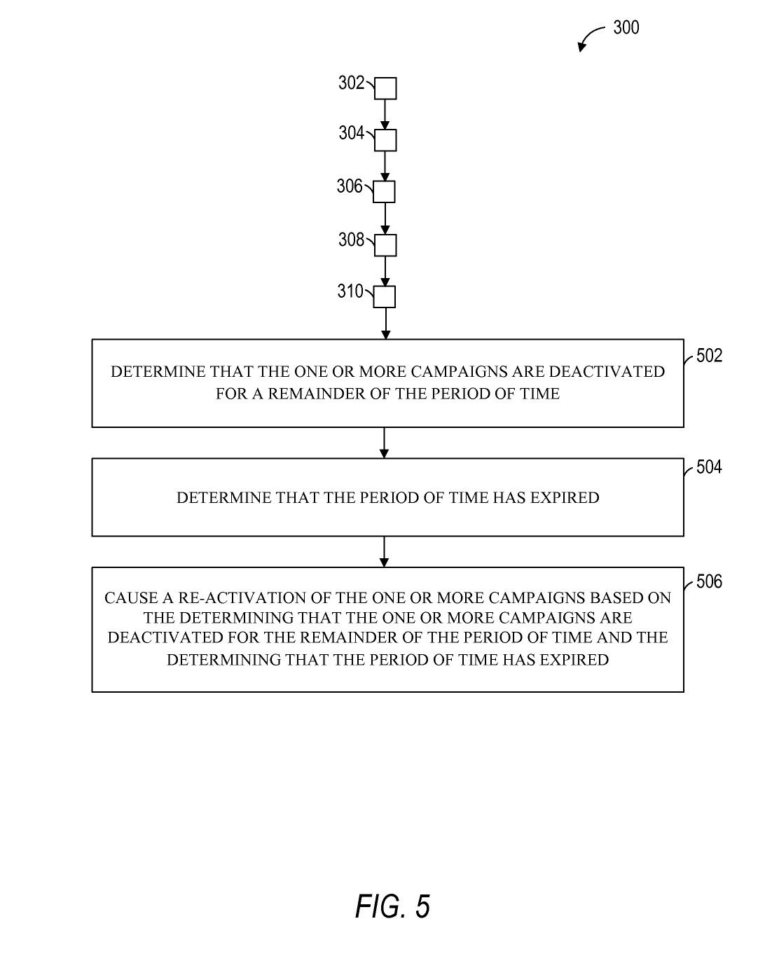

As shown in FIG. 5, the method 300 may include method operations 502, 504, and 506, according to some example embodiments. Method operation 502 may be performed after method operation 310, in which the adjuster module 206 adjusts the remaining period budget value based on the event cost value. At method operation 502, the analysis module 204 determines that the one or more campaigns are deactivated for a remainder of the period of time.

Method operation 504 may be performed after method operation 502. At method operation 504, the time module 210 determines that the period of time has expired.

Method operation 506 may be performed after method operation 504. At method operation 506, the ad serving control module 208 causes a re-activation of the one or more campaigns. The re-activation of the one or more campaigns may be based on the determining that the one or more campaigns are deactivated for the remainder of the period of time and the determining that the period of time has expired.

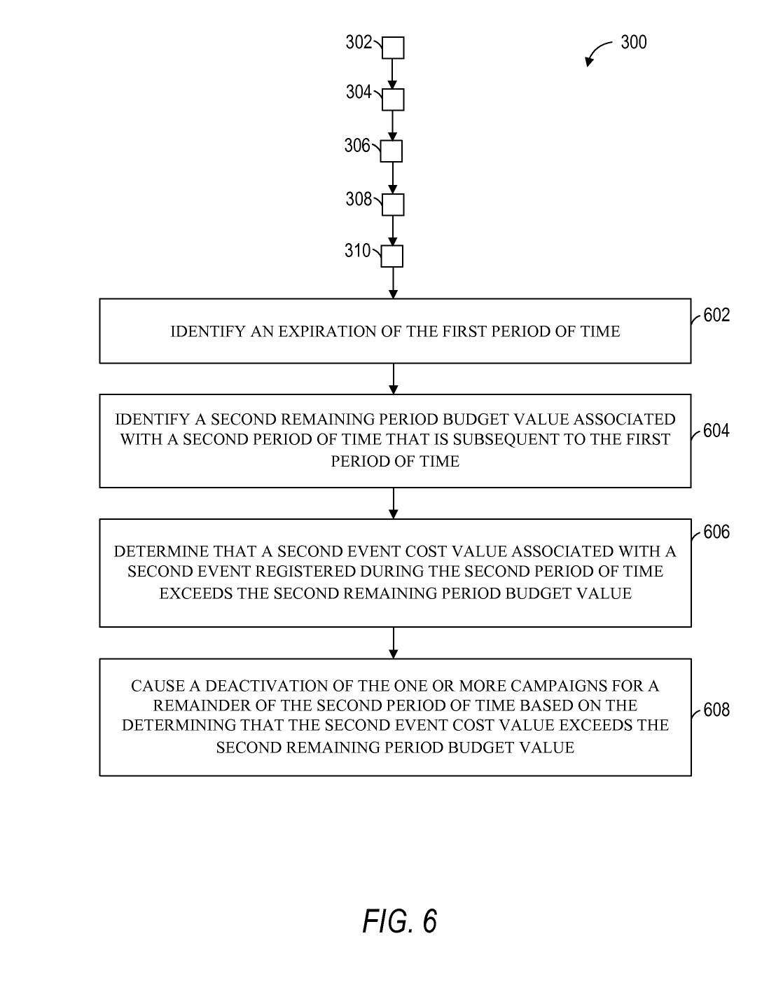

As shown in FIG. 6, the method 300 may include method operations 602, 604, 606, and 608, according to some example embodiments. Method operation 602 may be performed after method operation 310, in which the adjuster module 206 adjusts the remaining period budget value based on the event cost value.

In certain example embodiments, the event is a first event, the event cost value is a first event cost value, the period of time is a first period of time, and the remaining period budget value is a first remaining period budget value associated with the first period of time. At method operation 602, the time module 210 identifies an expiration of the first period of time.

Method operation 604 may be performed after method operation 602. At method operation 604, the access module 202 identifies (e.g., accesses) a second remaining period budget value associated with a second period of time that is subsequent to (e.g., follows after, immediately follows, etc.) the first period of time.

Method operation 606 may be performed after method operation 604. At method operation 606, the analysis module 204 determines that a second event cost value associated with a second event registered during the second period of time exceeds the second remaining period budget value.

Method operation 608 may be performed after method operation 606. At method operation 608, the ad serving control module 208 causes a deactivation of the one or more campaigns for a remainder of the second period of time. The deactivation may be based on the determining that the second event cost value associated with the second event registered during the second period exceeds the second remaining period budget value.

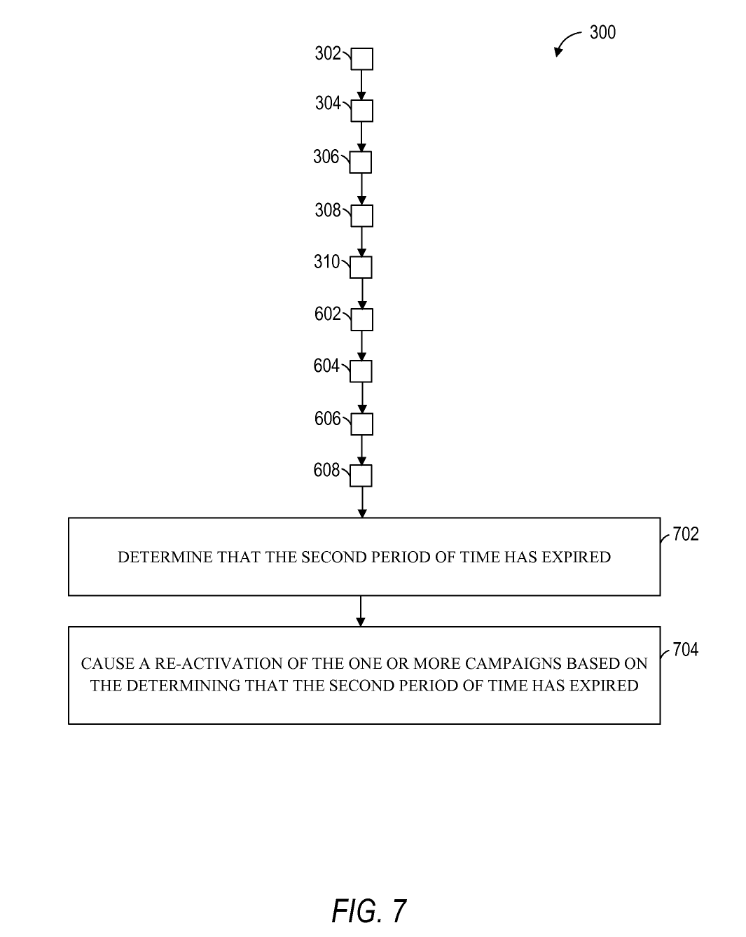

As shown in FIG. 7, the method 300 may include method operations 702 and 704, according to some example embodiments. Method operation 702 may be performed after method operation 604, in which the ad serving control module 208 causes a deactivation of the one or more campaigns that are associated with the account based on the identifying of the expiration of the first period of time. At method operation 702, the time module 210 determines that the second period of time has expired.

Method operation 704 may be performed after method operation 702. At method operation 704, the ad serving control module 208 causes a re-activation of the one or more campaigns. The re-activation may be based on the determining that the second period of time has expired.

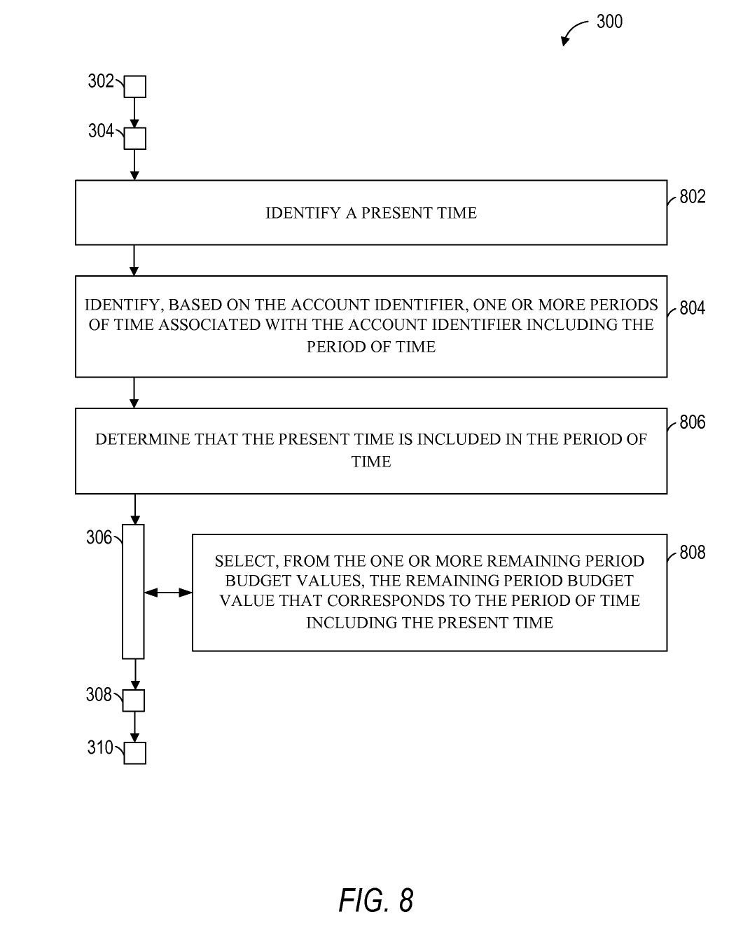

As shown in FIG. 8, the method 300 may include method operations 802, 804, 806, and 808, according to some example embodiments. Method operation 802 may be performed after method operation 304, in which the access module 202 identifies, based on the event data, an account identifier associated with the online ad. At method operation 802, the time module 210 identifies a present time.

Method operation 804 may be performed after method operation 802. At method operation 804, the time module 210 identifies, based on the account identifier, one or more periods of time associated with the account identifier including the period of time.

Method operation 806 may be performed after method operation 804. At method operation 806, the analysis module 204 determines that the present time is included in the period of time.

Method operation 808 may be performed as part (e.g., a precursor task, a subroutine, or a portion) of method operation 306, in which the access module 202 accesses a remaining period budget value associated with the account identifier. At method operation 808, the access module 202 selects, from the one or more remaining period budget values, the remaining period budget value that corresponds to the period of time including the present time.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

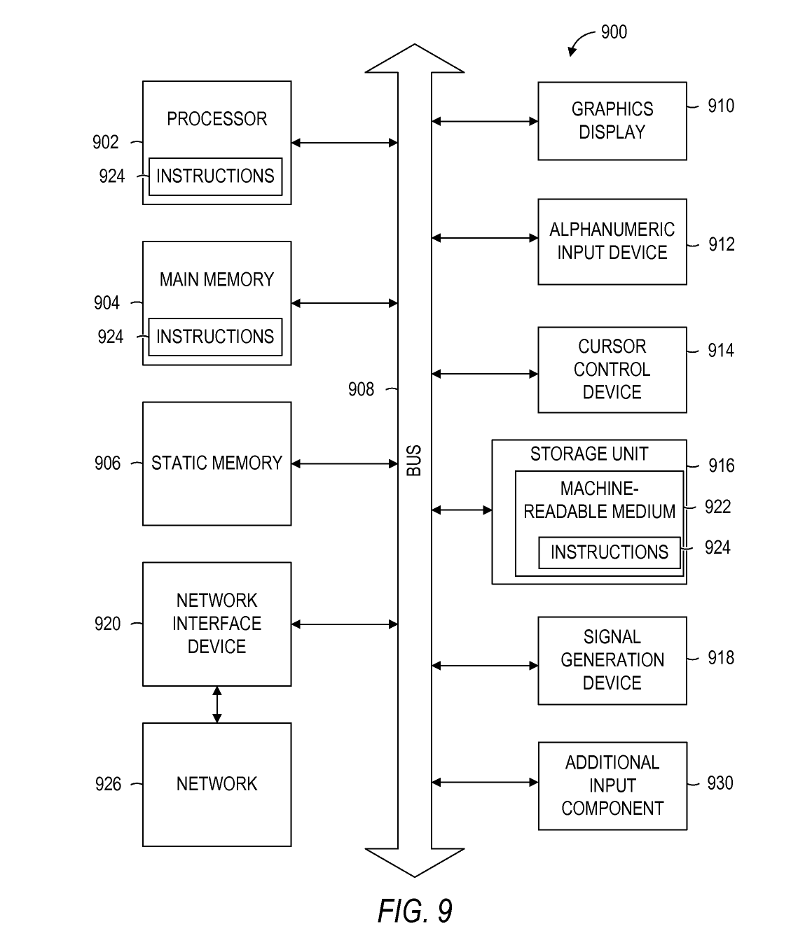

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 926 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing event data pertaining to an event of online ad consumption of an online ad included in a campaign, the campaign being one of one or more campaigns associated with an account;
identifying, based on the event data, an account identifier associated with the online ad;
accessing a remaining period budget value associated with the account identifier, the remaining period budget value representing a budget amount remaining to be spent, during a period of time, on one or more online ads that are associated with the one or more campaigns, the one or more online ads including the online ad;
determining, using one or more hardware processors, that the remaining period budget value exceeds an event cost value associated with the event; and
adjusting the remaining period budget value based on the event cost value.

2. The method of claim 1, further comprising:
adjusting, based on the event cost value, a remaining campaign budget value associated with the campaign that includes the online ad.

3. The method of claim 2, further comprising:
adjusting, based on the event cost value, a remaining account budget value associated with the account that is associated with the campaign that includes the online ad.

4. The method of claim 1, wherein the adjusting of the remaining period budget value based on the event cost value includes subtracting the event cost value from the remaining period budget value, a resulting difference becoming an updated remaining period budget value.

5. The method of claim 1, wherein the event is a first event, and the event cost value is a first event cost value, the method further comprising:
determining that a second event cost value associated with a second event of online ad consumption exceeds the remaining period budget value; and
causing a deactivation of the one or more campaigns that are associated with the account for a remainder of the period of time based on the determining that the second event cost value exceeds the remaining period budget value.

6. The method of claim 1, further comprising:
determining that the one or more campaigns are deactivated for a remainder of the period of time;
determining that the period of time has expired; and
causing a re-activation of the one or more campaigns based on the determining that the one or more campaigns are deactivated for the remainder of the period of time and the determining that the period of time has expired.

7. The method of claim 1, wherein the event is a first event, the event cost value is a first event cost value, the period of time is a first period of time, and the remaining period budget value is a first remaining period budget value associated with the first period of time, the method further comprising:
identifying an expiration of the first period of time;
identifying a second remaining period budget value associated with a second period of time that is subsequent to the first period of time;
determining that a second event cost value associated with the a second event registered during the second period of time exceeds the second remaining period budget value; and
causing a deactivation of the one or more campaigns for a remainder of the second period of time based on the determining that the second event cost value exceeds the second remaining period budget value.

8. The method of claim 7, further comprising:
determining that the second period of time has expired; and
causing a re-activation of the one or more campaigns based on the determining that the second period of time has expired.

9. The method of claim 1, wherein the period of time is a first period of time included in a second period of time, the remaining period budget value is a first remaining period budget value, and the second period of time is associated with a second remaining period budget value associated with the account identifier, the method further comprising:
accessing the second remaining period budget value;
determining that the second remaining period budget value exceeds the event cost value associated with the event; and
adjusting the second remaining period budget value based on the event cost value.

10. The method of claim 9, wherein the second remaining period budget value is further associated with a campaign group of the one or more campaigns.

11. The method of claim 9, wherein the second remaining period budget value is further associated with a line item in a contract between an advertiser associated with the account and a publisher of online ads included in the one or more campaigns.

12. The method of claim 1, wherein the account identifier is associated with one or more periods of time including the period of time, wherein the account identifier is associated with one or more remaining period budget values including the remaining period budget value, and wherein the one or more remaining period budget values correspond to the one or more periods of time, the method further comprising:
identifying a present time;
identifying, based on the account identifier, the one or more periods of time associated with the account identifier;
determining that the present time is included in the period of time, and
wherein the accessing of the remaining period budget value includes selecting, from the one or more remaining period budget values, the remaining period budget value that corresponds to the period of time including the present time.

13. A system comprising:
a machine-readable medium for storing instructions that, when executed by one or more hardware processors of a machine, cause the machine to perform operations comprising:
accessing event data pertaining to an event of online ad consumption of an online ad included in a campaign, the campaign being one of one or more campaigns associated with an account;
identifying, based on the event data, an account identifier associated with the online ad;
accessing a remaining period budget value associated with the account identifier, the remaining period budget value representing a budget amount remaining to be spent, during a period of time, on one or more online ads that are associated with the one or more campaigns, the one or more online ads including the online ad;
determining that the remaining period budget value exceeds an event cost value associated with the event; and
adjusting the remaining period budget value based on the event cost value.

14. The system of claim 13, wherein the event is a first event, and the event cost value is a first event cost value, and wherein the operations further comprise:
determining that a second event cost value associated with a second event of online ad consumption exceeds the remaining period budget value; and
causing a deactivation of the one or more campaigns that are associated with the account for a remainder of the period of time based on the determining that the second event cost value exceeds the remaining period budget value.

15. The system of claim 13, wherein the operations further comprise:
determining that the one or more campaigns are deactivated for a remainder of the period of time;
determining that the period of time has expired; and
causing a re-activation of the one or more campaigns based on the determining that the one or more campaigns are deactivated for the remainder of the period of time and the determining that the period of time has expired.

16. The system of claim 13, wherein the event is a first event, the event cost value is a first event cost value, the period of time is a first period of time, and the remaining period budget value is a first remaining period budget value associated with the first period of time, and wherein the operations further comprise:
identifying an expiration of the first period of time;
identifying a second remaining period budget value associated with a second period of time that is subsequent to the first period of time;
determining that a second event cost value associated with a second event registered during the second period of time exceeds the second remaining period budget value; and
causing a deactivation of the one or more campaigns for a remainder of the second period of time based on the determining that the second event cost value exceeds the second remaining period budget value.

17. The system of claim 16, wherein the operations further comprise:
determining that the second period of time has expired; and
causing a re-activation of the one or more campaigns based on the determining that the second period of time has expired.

18. The system of claim 13, wherein the period of time is a first period of time included in a second period of time, the remaining period budget value is a first remaining period budget value, and the second period of time is associated with a second remaining period budget value associated with the account identifier, and wherein the operations further comprise:
accessing the second remaining period budget value;
determining that the second remaining period budget value exceeds the event cost value associated with the event; and
adjusting the second remaining period budget value based on the event cost value.

19. The system of claim 13, wherein the account identifier is associated with one or more periods of time including the period of time, wherein the account identifier is associated with one or more remaining period budget values including the remaining period budget value, wherein the one or more remaining period budget values correspond to the one or more periods of time, and wherein the operations further comprise:
identifying a present time;
identifying, based on the account identifier, the one or more periods of time associated with the account identifier;
determining that the present time is included in the period of time, and
wherein the accessing of the remaining period budget value includes selecting, from the one or more remaining period budget values, the remaining period budget value that corresponds to the period of time including the present time.

20. A non-transitory machine-readable storage medium comprising instructions that, when executed by one or more processors of a machine, cause the machine to perform operations comprising:
accessing event data pertaining to an event of online ad consumption of an online ad included in a campaign, the campaign being one of one or more campaigns associated with an account;
identifying, based on the event data, an account identifier associated with the online ad;
accessing a remaining period budget value associated with the account identifier, the remaining period budget value representing a budget amount remaining to be spent, during a period of time, on one or more online ads that are associated with the one or more campaigns, the one or more online ads including the online ad;
determining that the remaining period budget value exceeds an event cost value associated with the event; and
adjusting the remaining period budget value based on the event cost value.
